(19) United States
(12) Patent Application Publication
(10) Pub. No.: US 2025/0384322 A1
(43) Pub. Date: Dec. 18, 2025

(54) SYSTEMS AND METHODS FOR INCREASING AI CREATIVITY BY INJECTING RANDOMNESS AND OTHER CHARACTERISTICS

(71) Applicant: Christopher James Thibault, Lexington, SC (US)

(72) Inventor: Christopher James Thibault, Lexington, SC (US)

(21) Appl. No.: 18/742,411

(22) Filed: Jun. 13, 2024

(51) Int. Cl. G06N 10/60; G06N 3/08

(52) U.S. Cl. CPC G06N 10/60; G06N 3/08

(57) ABSTRACT

The present disclosure is directed to systems and methods for injecting noise into artificial intelligence (AI) systems, such as neural networks. The noise can be intentionally, deliberately, or purposefully injected into the neural network or AI system or model. The noise can be random and can be injected into an inference process of an AI model. The noise can cause the AI system to explore and develop novel solutions that would not typically be generated by the AI system under purely deterministic conditions. This can provide the benefit of increasing the AI model's creativity.

### TECHNICAL FIELD

Embodiments of this disclosure relate generally to the field of artificial intelligence (AI) and more particularly to systems and methods for enhancing the creative capabilities of AI models by incorporating random noise during the inference process.

### BACKGROUND

Neural networks are advantageous because they are both inspired by and can have a structure that resembles the human brain. In a neural network, machine learning uses interconnected nodes or neurons in a layered structure to process data, much like the human brain.

While very powerful and useful, neural networks can suffer from drawbacks. One such drawback is overfitting, which can occur when a neural network learns to perform at a high level on training data but fails to apply its training, or cannot generalize on, new data. In one example, a neural network can “memorize” examples and other information used in training so well that the network fails to perform well on new, unseen real-world tasks.

Conventional AI models, especially those based on neural networks, are trained to provide deterministic or quasi-deterministic outputs for a given input. These outputs are generally based on patterns the AI model has learned during its training phase. However, the deterministic nature of such outputs sometimes curtails the AI model's ability to generate clever or out-of-the-box solutions. Viewed another way, different people may provide different outputs given the same set of inputs based on their personal views, experiences, and knowledge, and there is a desire for AI models to behave similarly and provide creative, more “human”-like outputs.

### SUMMARY

A need exists, therefore, for systems and methods of increasing AI and neural network creativity by injecting randomness and other characteristics. In various embodiments, noise can be injected into the neural network. In particular, the noise can be intentionally, deliberately, or purposefully injected into the neural network or AI system. The injected noise can be new or random, or controlled (or uncontrolled) in ways discussed herein.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

This disclosure may be more completely understood in consideration of the following description of various embodiments in connection with the accompanying figures, in which:

FIG. 1A is a simplified block diagram of the training of an AI model.

FIG. 1B is a simplified block diagram of use of the trained AI model of FIG. 1A.

FIG. 2 is a simplified block diagram for injecting noise into an AI model according to an embodiment of this disclosure.

FIG. 3 is a flowchart of a method of an embodiment of this disclosure.

FIG. 4 is a flowchart of a method of an embodiment of this disclosure.

While various embodiments are amenable to various modifications and alternative forms, specifics thereof have been shown by way of example in the drawings and will be described in detail. It should be understood, however, that the intention is not to limit the disclosure or claims to the particular embodiments described. On the contrary, the intention is to cover all modifications, equivalents, and alternatives falling within the spirit and scope of the subject matter as defined by the claims.

### DETAILED DESCRIPTION

The present disclosure is directed to systems and methods for injecting noise into an AI model. The noise can be intentionally, deliberately, or purposefully injected into the neural network or AI system or model. The noise can be controlled random noise and can be injected into the inference process of the AI model. This noise can cause the AI model to explore and develop novel solutions that would not typically be generated under purely deterministic conditions. This can provide the benefit of increasing the AI model's creativity.

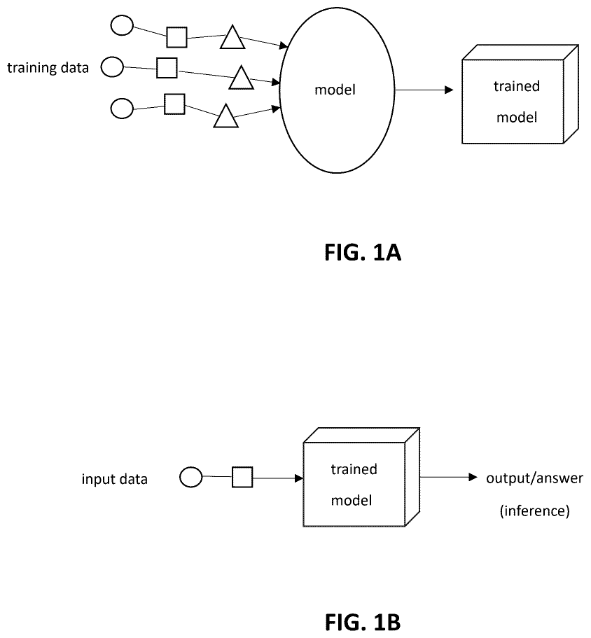

Generally speaking, an AI model is trained as is depicted in a simplified diagram in FIG. 1A. Training data is input into an AI model, and a trained AI model is produced by learning from patterns and relationships in the input data. Oftentimes the AI model continues to be trained, or refined, by continuous or updated training or actual data being input to the trained model.

In use, data is input into the trained AI model as is depicted in FIG. 1B, and an output or answer is provided. This output is an inference made by the AI model applying the input data to the trained model. An inference is a prediction or generalization from the (new) input data, based on the training that has been provided to the model.

While providing many benefits and being very useful, AI models like this are limited by several factors, including the input data set, whether or not they are updated or continuously trained, and the lack of free-thinking or personality (i.e., creativity) in current computer-run AI models.

Embodiments of the disclosure address these and other factors by providing systems and methods for introducing noise into the AI model. This noise can lead the AI model to explore novel solutions that would not typically be generated under deterministic conditions, thereby increasing the creativity of the AI model. In one example, the noise is controlled and random, and the degree or level of randomness (and therefore the degree or level of creativity of the AI model) can be varied.

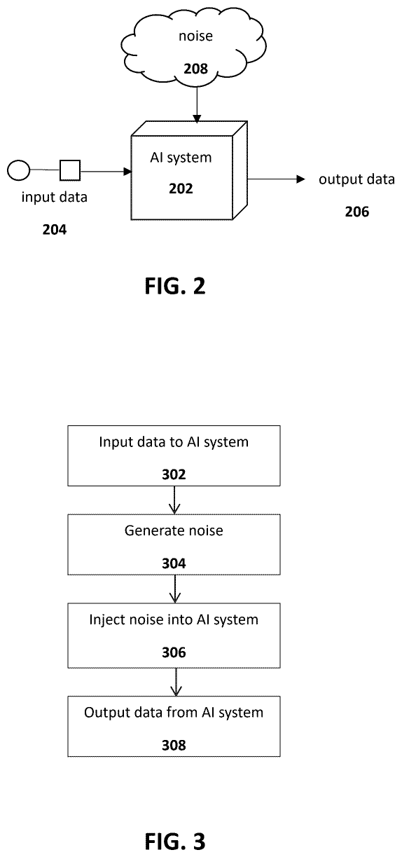

A simplified block diagram of an AI system according to an embodiment of this disclosure is depicted in FIG. 2. An AI system 202 can reside on or comprise at least one processor and memory. Likewise, input data 204 can reside on or be communicated to AI system 202 by or from at least one processor or stored in memory. Output data 206 can reside on or be provided to at least one processor or stored in memory. Furthermore, the noise generator can reside on or comprise at least one processor and memory.

The at least one processor of any of the components depicted in FIG. 2 can be any programmable device (or system or network of devices) that accepts digital data as input, is configured to process the input according to instructions or algorithms and provides results as outputs. In an embodiment, the at least one processor can be a central processing unit (CPU) or a microcontroller or microprocessor (or group of microcontrollers or microprocessors) configured to carry out the instructions of a computer program or software. The at least one processor is therefore configured to perform at least basic arithmetical, logical, and input/output operations.

The at least one processor includes or is communicatively coupled with memory or other digital storage and can comprise volatile or non-volatile memory as required by the at least one processor to not only provide space to execute the instructions or algorithms, but also to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, or optical disc storage, for example.

The foregoing examples in no way limit the types of processing hardware or systems, or memory hardware or systems, that can be used in various embodiments, as these examples are given only by way of example and are not intended to limit the scope of the present disclosure. For example, both the at least one processor and memory can be cloud-based but nevertheless comprise physical infrastructure on a server or server farm.

Thus, in FIG. 2, various processors and memory can be communicatively coupled with another to form the system as depicted. As already mentioned, FIG. 2 is a simplified depicted such that additional components, including other processors and hardware, can be included in various embodiments even though they are not depicted or described with respect to FIG. 2.

Referring also to the flowchart of FIG. 3, in one embodiment input data 204 is provided to AI system 202, at 302. Input data 204 is the data that AI system 202 is required or intended to process.

At 304, noise 208 is generated, such as by a noise generator. In one embodiment, the noise is random noise, generated using a pre-defined distribution (e.g., Gaussian, uniform, etc.). The magnitude, frequency, or type of noise can be adjusted based on the desired level of creativity. Additionally, by setting the noise magnitude to zero or turning off the noise generator, AI system 202 can revert to producing consistent and deterministic outputs. In some situations, producing outputs according to both noise-incorporated and no-noise models can be done, with the outputs compared or further processed. In other words, the noise generator (or noise 208 from the noise generator) can be turned on and off.

At 306, the generated noise 208 is injected or otherwise incorporated into the internal processes of AI system 202 during inference, leading to altered internal activations and, consequently, varied outputs. Thus, output data is provided by AI system 202 at 308. The output data is based on both the input data and the incorporated noise.

This approach can be applied to various neural networks architectures and approaches, including deep neural networks, recurrent neural networks, deep learning, convolutional neural networks, transformer models (such as BERT), and others. Embodiments and techniques discussed herein are also applicable in many other AI architectures, settings, systems, and methods.

For example, some embodiments and techniques of this disclosure can be used in supervised learning, unsupervised learning, and semi-supervised learning. In supervised learning, an algorithm learns from a labeled dataset, providing the algorithm with an answer key to learn a mapping from inputs to outputs. In unsupervised learning, algorithms infer patterns from a dataset without reference to known or labeled outcomes. In semi-supervised learning, algorithms learn from a smaller amount of labeled data and a larger amount of unlabeled data. There are also applications in reinforced learning, in which algorithms learn to make decisions by taking actions in an environment to achieve some objectives, and Q-learning.

Embodiments and techniques of this disclosure also can be used in applications related to or including linear regression, logistic regression, decision trees, random forests, support vector machines (SVM), naive Bayes, K-nearest neighbors (KNN), gradient boosting algorithms (e.g., XGBoost, LightGBM, CatBoost), clustering, K-means, hierarchical cluster analysis (HCA), expectation maximization (EM), DBSCAN, dimensionality reduction, principal component analysis (PCA), t-distributed stochastic neighbor embedding (t-SNE), autoencoders, association rules, apriori, equivalence class clustering and bottom-up lattice traversal (ECLAT), self-training, co-training, transductive support vector machines, label propagation, deep Q networks (DQN), policy gradient methods (including REINFORCE), actor-critic methods, proximal policy optimization (PPO), deep deterministic policy gradient (DDPG), diffusion, anomaly detection, isolation forest, one-class SVM, recommendation systems, collaborative filtering, content-based filtering, hybrid systems, natural language processing (NLP), bag of words (BoW), Word2Vec, generative models, generative adversarial networks (GANs), and variational autoencoders (VAEs), among others.

Generally speaking, embodiments can be useful in situations in which creative solutions are required or helpful. A more creative AI can be incredibly helpful in a variety of fields, pushing the boundaries of innovation, problem-solving, and artistic expression. These can include content generation, art creation, music composition, brainstorming, problem-solving, and myriad others. Several particular but non-limiting examples in which a more creative AI could make significant contributions follow.

A first example is in product design and innovation. AI could generate novel concepts, with a creative AI able to propose unique designs for products, from everyday items to complex machinery, potentially revolutionizing industries by introducing efficiency or functionalities of which humans might not conceive. Creative AI also may be able to create personalized or customized designs based on individual preferences or requirements, enhancing user experience in sectors like fashion, interior design, and consumer electronics.

Other example applications of more creative AI are in entertainment and art. In music composition, for example, creative AI can compose music in various styles, potentially creating new genres or providing artists with inspiration for their compositions. In film and video game development, creative AI can generate content, plot ideas, or even entire narratives, offering new storytelling possibilities. More broadly, creative AI could be useful in everything from scripting to visual effects. Creative AI also could produce digital artworks in a range of styles, challenging our understanding and concepts of creativity and authorship.

In advertising and marketing, creative AI could be used in ad campaigns to generate innovative marketing strategies, slogans, and visuals, tailoring content to specific audiences with unprecedented precision. From writing engaging articles to producing informative videos, AI can help create diverse content, keeping it fresh and relevant.

In the fields of education and training, AI could be used in curriculum design. For example, creative AI can design educational materials that adapt to a learner's style and pace, making learning more effective and engaging. There also can be application in simulation and training, such as in fields like surgery or aviation. Here creative AI could develop realistic simulation scenarios, enhancing training programs with scenarios that mimic real-life challenges.

In science and engineering, creative AI could help with research and development, such as by hypothesizing new scientific theories or engineering principles by combining vast amounts of data in novel ways. Creative AI also could assist with computer hardware advances. The integration of custom silicon into computing architectures could represent a pivotal advancement in enhancing the scalability and feasibility of injecting random noise into neural networks to boost creativity. Custom silicon designs, tailored specifically to facilitate operations critical for random noise injection, could transform the landscape of creative AI applications.

Injecting randomness into deterministic environments of neural networks has emerged as a promising approach to unlocking new levels of creativity and diversity in AI outputs. However, the computational demands of these techniques have historically placed constraints on their practical application, particularly at scale. The development of custom silicon, designed explicitly for AI computations, offers a solution to these challenges, enabling more efficient and effective implementation of random noise injection methods. Custom silicon chips, engineered specifically for AI tasks, can perform complex calculations more efficiently than general-purpose processors. By optimizing for operations such as parallel processing and low-latency data access, these chips can significantly reduce the computational overhead associated with random noise generation and application. This efficiency is crucial for real-time creativity in applications like live generative art and interactive AI systems.

Moreover, custom silicon solutions bring the added benefit of improved energy efficiency, a critical factor in the sustainability of large-scale AI deployments. These specialized chips can be seamlessly integrated with existing AI frameworks and platforms, enhancing their versatility. Beyond generative art and interactive AI systems, custom silicon has potential applications in areas such as autonomous systems, natural language processing, and advanced robotics, where real-time processing and adaptive responses are paramount.

As the field of AI continues to evolve, the scalability of neural network models will be increasingly influenced by the underlying hardware's capability to handle vast amounts of data and perform numerous calculations simultaneously. Custom silicon can be architected to support extensive parallelism and high-throughput data processing, essential for training and deploying large, creative AI models. Looking ahead, the ongoing advancements in custom silicon technology promise to further push the boundaries of what is possible in AI, driving innovations that were previously unimaginable.

Examples of noise 208 generated by the noise generator will now be provided. First, assume the random noise N is generated from a Gaussian distribution:

$$N \sim N ( μ , {σ}^{2} )$$

where:
   μ is the mean (typically set to 0 for centered noise), and
   σ² is the variance, controlling the magnitude of the noise.
For instance, if minor noise disturbances are desired in a particular model, σ might be set to a small value.

With respect to noise injection (e.g., at 306 in FIG. 3), suppose the inference process of AI system 202 involves a forward pass through a neural network layer described by:

$$O = f ( I \times W + b )$$

where:
   l is the input matrix (batch size x input features),
   W is the weight matrix (input features x output features),
   b is the bias vector (output features),
   f is the activation function (e.g., ReLU, sigmoid), and
   O is the output matrix (batch size x output features).
With noise injection, this equation becomes:

$${O}^{′} = f ( I \times ( W + NW ) + ( b + {N}_{b} ) )$$

where:
   NW is the noise matrix for weights, generated similarly as N, and
   Nb is the noise vector for biases, also generated from the Gaussian distribution.
Therefore, this new equation O′ shows how the noise alters the internal activations and thus the outputs of AI system 202 in various embodiments.

Furthermore, and as previously mentioned, the level of creativity provided by injecting noise into AI system 202 can be adjusted by varying σ. For example:
High creativity: σ_{high}
Medium creativity: σ_{medium}
Low creativity: σ_{low}
   where σ_{high}>σ_{medium}>σ_{low}.
   By adjusting σ, users can control how “wild” or “conservative” the outputs of AI system 202 become. This can be advantageous in several respects, including to generate multiple outputs with varying creativity for the same input data, or to vary the level of creativity based on the application of AI system 202.

In various embodiments, certain AI techniques can be implemented with or as part of noise-enhancement of AI system 202. For example, dropout-enhanced creativity can be applied. In AI, dropout is a regularization technique in which, during training, a random subset of neurons (and their corresponding connections) are “dropped out” or temporarily removed from the neural network of an AI model. For creative inference purposes, however, dropout can be used during the inference phase, even though this is not its typical application.

Dropout implementation can be described mathematically as follows. Given an output OO from a layer in the neural network:

$$O = f ( I \times W + b )$$

When dropout is applied during inference, this output becomes:

$${O}^{′} = d ⊙ f ( I \times W + b )$$

where:
   ⊙ is the element-wise multiplication (e.g., Hadamard product),
   d is a binary mask vector/matrix with values sampled from a, e.g., Bernoulli distribution: dᵢ˜Bernoulli (p), and
   p is the probability that an element/neuron is “kept” (not dropped out) (typically, p is set to values like 0.5 during training, but can be adjusted during inference for varying levels of creativity according to embodiments of this disclosure).
By adjusting the value of p, the degree of randomness and thus the creativity of AI system 202 can be controlled:
   High creativity: p_{low} (e.g., 0.2 or 0.3, meaning many neurons are dropped out)
   Medium creativity: p_{medium} (e.g., 0.5)
   Low creativity: p_{high} (e.g., 0.8 or 0.9, meaning most neurons are kept)

Other embodiments can apply optimization with fast Fourier transform (FFT)-induced local minima. This can help to find optimal coefficients for a polynomial regression model that incorporates random noise processed via FFT to introduce designed local minima.

Mathematically, and given input data x, the polynomial regression function is given by:

$$P ( x ) = {a}_{0} + {a}_{1} x + {a}_{2} {x}_{2} + … + {a}_{n} {x}_{n}$$

To each sample of input data x, random noise N derived from a Gaussian distribution can be introduced:

$${x}^{′} = x + {N}_{x}^{′} = x + NN ∼ N ( μ , {σ}^{2} )$$

Then, FFT can be performed on x′x′ to transform the data into the frequency domain:

$${X}^{′} = FFT ( {x}^{′} )$$

This also can be modified using an inverse FFT (IFFT). In such an embodiment, the frequency domain data X′X′ can be modified by setting specific frequency components to zero (or reducing their amplitude) to create designed local minima when the inverse FFT is applied:

$${X}^{″} = {X}^{′} ⊙ M$$

where MM is a mask that defines which frequency components are retained or set to zero.
Now, the modified data set can obtained according to:

$${x}^{″} = IFFT ( {X}^{″} )$$

It also can be advantageous in some embodiments to use gradient descent (or any other suitable optimization technique) to fit the polynomial coefficients on x″. Due to the FFT-induced changes, the optimization process should now navigate through local minima introduced by this process.

Optional iterative refinement can be carried out by repeating one or both of the FFT and IFFT operations described above, one or multiple times, during the optimization process to introduce varying local minima challenges. This can ensure the optimization process does not get trapped in unfavorable regions and helps explore a broader solution space for desired creativity by AI system 202.

In yet another possible embodiment, FFT-enhanced polynomial regression with random noise and dropout can be applied to AI system 202. This can harness the combined powers of polynomial regression, random noise injection, dropout techniques, and FFT transformations, creating a robust and intricate optimization landscape ideal for training and implementing resilient AI models, including AI system 202 as discussed herein.

At the core of this example method is polynomial regression, a technique that aims to fit data using a polynomial function of degree nn:

$$P ( x ) = a 0 + a 1 x + a 2 x 2 + … + anxn$$

Polynomials, being universal approximators, can model a wide range of behaviors, providing flexibility in representing complex datasets.

Additionally, random noise injection can be considered to be a thermal analog. Every system in the physical world experiences some level of “noise,” often due to thermal fluctuations. By introducing Gaussian noise NN to the data, this physical phenomenon can be mimicked:

$${x}^{′} = x + {Nx}^{′} = x + N N ∼ N ( μ , {σ}^{2} )$$

In other words, just as thermal energy can push particles out of local minima in physical systems, noise can help the optimization algorithm avoid getting trapped in local solution pockets.

Returning again to dropout, it can be visualized as creating redundancy in a system. By randomly deactivating parts of the data (akin to shutting down certain pathways or nodes in a network) the system can be forced to become resilient:

$${x}^{′} = d ⊙ {x}^{′}$$

This approach is reminiscent of ways in which redundant systems in engineering, such as backup power supplies, ensure that the main objective (e.g., power delivery) continues even when primary systems fail.

Moving to the frequency domain is akin to changing perspective from looking at individual events (such as stock prices on specific days) to recognizing broader trends or cycles (such as economic booms or recessions). By applying FFT the data can be transformed into a realm in which patterns, cycles, and trends become more apparent, offering a different landscape for manipulation:

$$X = FFT ( {x}^{″} )$$

In some embodiments, the frequency domain manipulation can be applied. Just as a landscape architect might mold the earth to create hills and valleys, data can be modulated in the frequency domain to design an optimization landscape:

$${X}^{′} = X ⊙ M$$

This provides a toolset to sculpt the energy surface of the optimization problem. By amplifying or attenuating certain frequency components, valleys (local minima) and hills (local maxima) can be designed, thereby defining the challenges the optimization algorithm must navigate and further refining the level of creativity that may be exhibited by AI system 202.

After frequency domain manipulations, the time (or spatial) domain can be returned to as this is where the data's original representation resides:

$${x}^{′′′} = IFFT ( {X}^{′} )$$

Optimization in a crafted landscape also can be implemented. With the transformed data x″, an optimization phase can be entered. Gradient descent or its kin can be used to fit the polynomial coefficients. The interplay of noise, dropout, and FFT-induced changes presents a multifaceted optimization terrain. This varied terrain encourages thorough exploration by AI system 202, akin to how varied training (e.g., cross-training) prepares athletes for unpredictable real-world challenges.

The architecture of the neural (or other) network of AI system 202 also can be considered. Traditional feed-forward neural networks include input, hidden, and output layers. Each neuron is often connected to every other neuron in adjacent layers, leading to a vast parameter space even in modest-sized networks. The following applications of noise and other techniques discussed herein can be considered.

Random noise injection can be used. For example, noise can be injected into the input layer or even into hidden layers. This challenges the neural network (e.g., of AI system 202) to generalize better and not overfit to specific input-output mappings.

Next, and even though commonly used in neural networks, dropout can be applied more strategically in embodiments of this disclosure, such as by using the FFT approach to determine optimal dropout patterns based on frequency domain analysis.

Even though data might not always be polynomial, Fourier transformations can still be applied to activations within layers, sculpting the optimization landscape in the hidden layers and enriching the training process.

Additionally, deep neural networks (DNNs), which have multiple layers, capture intricate patterns in data. However, they are notorious for overfitting and can get stuck in local minima. Therefore, the aforementioned (or additional) techniques can be applied.

In one example, introducing noise at various layers, not just the input, can help DNNs generalize across depths, ensuring robustness throughout the network.

Considering dropout again, it can be important for DNNs and extended with the FFT strategy to manipulate frequency-based patterns in data, making the dropout process more informed and dynamic.

Using FFT manipulation, activations in deeper layers can be transformed into the frequency domain, allowing for intricate manipulations that affect the subsequent layers and, ultimately, the output. This promotes robust feature extraction across layers.

In yet another embodiment, AI system 202 is a large language models (LLMs). One example of an LLM is a generative pre-trained transformer (GPT), which is designed to generate human-like text or language by predicting the next word in a sentence based on the words that came before it. LLMs have an extensive parameter space, making their training computationally demanding. They tend to memorize specifics from vast amounts of data, risking overfitting.

Thus, the aforementioned techniques (e.g., random noise injection, dropout, and FFT manipulation) can be applied in embodiments in which AI system 202 is or comprises an LLM, such as in the following ways:
Random noise injection: Given the sequential nature of language, introducing noise in the input sequences or even in intermediate representations can help the model generalize better across various linguistic patterns.
Dropout: Dropout in LLMs can prevent over-reliance on particular neurons or sequences, making the model more resilient to varied inputs.
FFT manipulation: Sequences in language have inherent rhythms and patterns (akin to frequencies). By transforming these sequences or intermediate representations to the frequency domain, they can be manipulated them in ways that promote generalization and challenge the model to learn more holistic linguistic features.

Therefore, embodiments of the noise generation and injection discussed herein can be advantageous to add or increase the creativity of AI models. The FFT-enhanced polynomial regression method discussed herein provides tools that can be adapted for various neural architectures, including LLMs. Its principles, grounded in creating a rich optimization landscape and promoting generalization, align well with the challenges faced by these architectures, making it a valuable strategy for the next generation of AI models. In some embodiments, it can be possible to observe and study the impacts of these methods on various specific architectures through empirical research and adapt and refine the methods to be more suited for each context.

Now considering the mathematical application to neural networks, given input xx and weight matrix WW for the first layer, the output y after the layer can be described as:

$$Y = σ ( {W}_{x + b} )$$

where σ is the activation function (such as ReLU, Sigmoid, etc.) and bb is the bias.

Random noise injection can be accomplished by introducing Gaussian noise to the neural network input:

$${x}^{′} = x + {Nx}^{′} = x + N N ∼ N ( μ , {σ}_{2} )$$

This modified x′ is now used for the forward pass:

$${y}^{′} = σ ( {Wx}^{′} + b )$$

For dropout in neural networks, a mask dd with values typically being 0 (drop) or 1 (keep) can be applied. This mask is element-wise multiplied with the output after the activation function:

$${y}^{″} = d ⊙ {y}^{′}$$

Neural activations, especially in deeper layers, can have patterns that might be interesting in the frequency domain, such that FFT processing can be beneficial. To do this, the dropout-adjusted activations can be transformed to the frequency domain as follows:

$$Y = FFT ( {y}^{″} )$$

As mentioned before, specific frequency components can be modulated to introduce designed local minima, to accomplish frequency domain manipulation:

$${Y}^{′} = Y ⊙ M$$

where MM is a modulation mask.

To then return to the time domain, use the following:

$${y}^{′′′} = IFFT ( {Y}^{′} )$$

For the next layer or subsequent layers, y′″ can be used as input. If there is a weight matrix W2 for the next layer:

$${y}_{2} = σ ( W 2 {y}^{′′′} + {b}_{2} )$$

Then, repeat the aforementioned operations (e.g., from noise injection to frequency domain manipulations) for subsequent layers as desired.

For DNNs, the depth of the network means there are multiple layers where these transformations can be applied. Depending on the depth, the layers to which the FFT transformations are applied can be strategically chosen to avoid overcomplicating the optimization landscape.

For LLMs, it can be important to remember that data (e.g., text) is sequential. This means the FFT can help extract patterns from large chunks of sequences. Given the vast parameter space of LLMs, however, computational costs should be considered as they may be significant.

Applying these techniques to neural networks offers a mathematical approach to shaping the optimization landscape, providing potential benefits in training robust models. There are practical implications and computational costs to be considered, however. Therefore, it can be helpful to test these ideas empirically, comparing the performance of modified networks against traditional training methods, to gauge the real-world efficacy of these techniques on particular AI models (e.g., AI system 202).

Another neural network creativity-enhancing technique that can be applied in embodiments of this disclosure is layer-to-layer interference. This can introduce controlled interference patterns between adjacent layers of neural networks to encourage non-linear, unconventional model responses, simulating increased creativity in the neural network's decision-making.

First, it is helpful to understand neural interference. Drawing parallels from physics, when two waves superimpose they can interfere constructively (amplify each other) or destructively (cancel each other out). Here, the outputs from one layer (treated as waveforms for the purposes of this example) will interfere with (or influence) those of subsequent layer(s), creating complex patterns of activations.

Then, the following can be used to implement interference. Given two consecutive layers with outputs y1 and y2, create an interference pattern I:

$$I = {y}_{1} ⊙ F ( {y}_{2} )$$

where F is a function mapping the output of layer 2 to an interference pattern compatible with y1. This could be a simple transform, a convolution, or another neural layer, for example. Then, feed this interference pattern II to the subsequent layer instead of the traditional output y2.

It is also possible to use weighted interference control. In this technique, a weight aa can be introduced to control the extent of interference:

$${y}_{final} = α {y}_{2} + ( 1 - α ) I$$

where y_{final} is the output that moves to the subsequent layer. By adjusting a, a smooth transition between traditional neural outputs and interference-influenced outputs can be achieved.

For deeper networks, interference can be recurrently applied between consecutive layers. This iterative interference application can further magnify unconventional patterns in the network's behavior.

Another technique that can be applied in embodiments of this disclosure is quantum interference for enhanced quantum neural network (QNN) creativity. QNNs are computational neural networks that are based on principles of quantum mechanics. Quantum mechanics explain how extremely small objects simultaneously behave as both particles (small pieces of matter) and waves (disturbances or variations in energy). An objective of this technique is to harness quantum principles of superposition and entanglement to introduce controlled interference patterns between adjacent layers of QNNs, encouraging diverse and potentially creative responses.

First, a brief explanation of quantum superposition in QNNs will be provided. A qubit in a quantum computer can be in a superposition of the |0 [symbol] and |1 [symbol] states. When multiple qubits are in superposition, they can represent an exponentially large computational space. In the context of QNNs, this allows the representation of a vast range of possible states simultaneously.

$$/ q 〉 = α / 0 〉 + β / 1 〉$$

where α and β are complex coefficients.

In some embodiments, entanglement for layer interference can be applied. Entanglement is a uniquely quantum phenomenon in which qubits become linked in such a way that the state of one qubit is dependent on the state of another. This can be harnessed to create interference between QNN layers.

Thus, for two consecutive layers with qubit states |q1 [symbol] and |q2 [symbol] , entangle them:

$$/ qent 〉 = ( / q 1 〉 ⊗ / q 2 〉 ) U$$

where U is a unitary transformation (e.g., a quantum gate) that creates the desired entanglement.

For interference-driven activation, an important operation in QNNs is measurement. After processing qubits, they are measured, collapsing to a definite state (|0 [symbol] or |1 [symbol] ). By designing the aforementioned entanglement strategically, the quantum interference can be guided such that, upon measurement, the QNN exhibits diverse outputs, akin to enhanced creativity.

Layer-to-layer quantum tunneling can be used, such as by leveraging quantum tunneling to enable qubits to move between energy states, thus introducing an additional form of interference. This can be visualized as qubits “tunneling” between layers, blending activations and enhancing non-linear interactivity between QNN layers.

Controlled quantum interference also can be applied by introducing quantum control gates to adjust the extent of interference, allowing for a balance between conventional QNN behavior and interference-driven creativity.

Another technique that can be used in various embodiments is deep quantum neural network operation on quantum computers. Thus, one can operate a multi-layered neural network on quantum hardware, leveraging qubits and quantum principles to process information and make predictions.

This can begin with quantum state preparation. Begin with the input layer, and convert classical data into quantum data by mapping it onto qubits. For a binary input vector |x [symbol] |x [symbol] , this can be represented as:

$$/ x 〉 = x 0 / 0 〉 + x 1 / 1 〉$$

For multi-dimensional data, tensor products of qubit states can be used.

In classical deep learning, neuron activations are obtained using functions like ReLU, sigmoid, and others as appreciated by those of ordinary skill in the art. In a QNN, unitary transformations (quantum gates) can be used to achieve this. For a given qubit in state |ψ [symbol] :

$$/ {ψ}^{′} 〉 = U / ψ 〉$$

where U is a unitary matrix representing the quantum gate. The transformed qubit state |ψ [symbol] is the “activated” state.

Layer-wise quantum operations can be considered as follows. In deep QNNs, each layer's qubits are sequentially operated upon by a series of quantum gates. For a two-qubit operation between states |ψ1 [symbol] and |ψ2 [symbol] :

$$/ ψ out 〉 = U 12 ( / ψ 1 ) ⊗ / ψ 2 〉 )$$

where U12 is the two-qubit gate, and ⊗ denotes the tensor product.

Quantum entanglement can be used to ensure neurons (qubits) in different layers are interlinked, enabling richer representations for inter-neuron communication:

$$/ {ψ}_{ent} 〉 = ( / ψ 1 〉 ⊗ / ψ 2 〉 ) {U}_{ent}$$

Here, Uₑₙₜ is a unitary transformation creating entanglement.

After processing through all QNN layers, qubits are measured. The probabilities obtained during measurements correspond to the network's output predictions. Given a qubit in state |ψ [symbol] :

$$P ( 0 ) = / 〈 0 / ψ 〉 / 2$$

$$P ( 1 ) = / 〈 1 / ψ 〉 / 2$$

These probabilities P(0) and (1) can be mapped to classical data, serving as the QNN's predictions.

Training in QNNs involves iteratively adjusting the unitary transformations (akin to weight adjustments in classical networks) based on some objective or loss function. Quantum phase estimation and quantum gradient techniques can be employed to optimize the network.

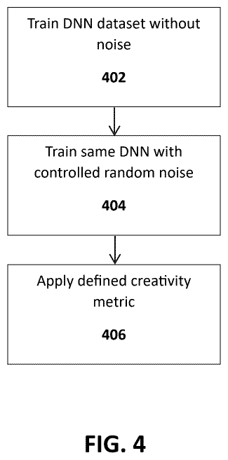

Results of random noise introduction to a deep neural network (DNN) can be tested by introducing controlled random noise at varying intensities between layers of a DNN and evaluating the subsequent “creativity” of the network's outputs. Referring to FIG. 4, a DNN is trained on a given dataset without noise to produce a baseline model, at 402. Then the same DNN architecture can be trained by introducing controlled random noise between layers, at 404. At 406, a defined creativity metric can be used, which evaluates the diversity and novelty of the DNN's outputs between the baseline model (402) and with noise (404).

Test results for one example embodiment are shown below.

TABLE 1
Test results for random noise introduction to a DNN

| | Creativity Score | |
|---|---|---|
| Test Condition | (Baseline = 100) | % Increase from Baseline |
| No noise | 100 | 0% |
| Low noise | 110 | 10% |
| Medium noise | 150 | 50% |
| High noise | 140 | 40% |

This data shows that introducing a medium level of random noise between layers in the DNN led to a 50% increase in the apparent creativity of the network, as per the defined metric. However, excessive noise (high noise) seemed to slightly reduce this enhancement.

In another approach, random noise and inter-node interference can be combined for enhanced inference in DNNs. This can improve the creative and diversified outputs of DNNs during inference by introducing controlled random noise and stimulating interference between nodes (neurons).

For random noise injection, let the output of a neuron n in layer L be represented as ynL. Introduce noise e such that:

$${y}_{n L} = f ( {w}_{n L} \cdot x + b + ϵ )$$

where f is the activation function, wnL is the weight vector, x is the input vector, b is the bias, and ϵ is a random noise vector sampled from a defined distribution (e.g., Gaussian).

Interference can be stimulated by blending the outputs of multiple nodes. If yn1L and yn2L are outputs of two neurons n1 and n2 in layer L, their combined output with interference I is:

$$ynintL = yn 1 L + yn 2 L + I ( yn 1 L , yn 2 L )$$

where I is the interference function, which might involve operations like element-wise multiplication, convolution, or other defined operations to instigate interference.

To ensure that the introduced noise and interference do not degrade the network's essential functionality, an adaptive control mechanism adjusts the intensity of both noise and interference based on feedback from the network's outputs:

$${ϵ}_{n e w} = α \cdot ϵ + ( 1 - α ) \cdot δ$$

$${I}_{n e w} = β \cdot I + ( 1 - β ) \cdot γ$$

where α and β are adaptive coefficients, δ represents the feedback-driven adjustment to the noise, and γ represents the feedback-driven adjustment to the interference.

During inference, for a given input x, the network calculates node outputs while integrating random noise and inter-node interference. The final layer outputs are aggregated, typically via a softmax function for classification tasks, to provide the network's prediction.

Thus, by amalgamating controlled random noise with dynamic inter-node interference during inference, this method seeks to achieve richer and potentially more diverse outputs from deep neural networks. The adaptive mechanism ensures a balance between enhanced creativity and the retention of primary network functionality. However, as with any advanced technique, thorough empirical validation can be used to confirm the method's efficacy in real-world applications.

In one example of this, take a simple feed-forward neural network implemented using TensorFlow/Keras and integrate the described method. Note that this example will use simplistic methods for interference and random noise injection.

```
CODE (PYTHON)
import tensorflow as tf
import numpy as np
# Define the interference function
def interference(output_1, output_2):
  # Simple element-wise multiplication as interference
  return np.multiply(output_1, output_2)
# Define the adaptive mechanism
def adaptive_mechanism(value, feedback, alpha):
  return alpha * value + (1 − alpha) * feedback
# Load or create your dataset here
# x_train, y_train, x_test, y_test = ...
# Define the model
model = tf.keras.models.Sequential([
  tf.keras.layers.Dense(128, activation=‘relu’, input_shape=(784,)), # example for MNIST
  tf.keras.layers.Dense(64, activation=‘relu’),
  tf.keras.layers.Dense(10, activation=‘softmax’)
])
model.compile(optimizer=‘adam’, loss=‘sparse_categorical_crossentropy’, metrics=[‘accuracy’])
# Train the model
# model.fit(x_train, y_train, epochs=5)
# During inference:
x_sample = np.random.random((1, 784)) # Replace with actual sample
# Forward pass without interference and noise for baseline
baseline_output = model.predict(x_sample)
# Extract outputs from two layers for interference
layer_1_output = tf.keras.models.Model(inputs=model.inputs,
outputs=model.layers[0].output).predict(x_sample)
layer_2_output = tf.keras.models.Model(inputs=model.inputs,
outputs=model.layers[1].output).predict(x_sample)
# Compute interference
I = interference(layer_1_output, layer_2_output)
# Inject random noise and interference
noise = np.random.normal(0, 0.1, layer_1_output.shape) # Gaussian noise
adjusted_output_1 = adaptive_mechanism(layer_1_output, noise, 0.7) + I
# Replace original output with the adjusted output and complete forward pass
interference_model = tf.keras.models.Sequential([
  tf.keras.layers.InputLayer(input_shape=(784,)),
  tf.keras.layers.Dense(128, activation=‘relu’, weights=model.layers[0].get_weights( )),
  tf.keras.layers.Dense(64, activation=‘relu’, weights=model.layers[1].get_weights( )),
  tf.keras.layers.Dense(10, activation=‘softmax’, weights=model.layers[2].get_weights( ))
])
adjusted_output = interference_model.predict(adjusted_output_1)
print(“Baseline Output:”, baseline_output)
print(“Adjusted Output:”, adjusted_output)
END CODE
```

Entropy is mentioned in the above example and can be expressed as H(X), a measure of uncertainty or randomness in a random variable X. For a discrete random variable X with probability mass function p(x), the entropy is defined as:

$$H ( X ) = - {\sum }_{x} p ( x ) log p ( x )$$

Mutual information (I(X;Y)) is a measure of the mutual dependence between two variables. It quantifies the amount of information obtained about one random variable through the other. For discrete random variables XX and YY, it is defined as:

$${\sum }_{x , y} p ( x , y ) log [ ( p ( x , y ) ) / p ( x ) p ( y ) ]$$

where p(x,y) is the joint probability mass function of X and Y, and p(x) and p(y) are the marginal probability mass functions of X and Y, respectively.

Noise N and crosstalk C can be modeled as random variables with their respective entropies H(N) and H(C). The entropy of the system with noise and crosstalk, H(S), can be influenced by both, along with their interaction.

Considering N and C as independent contributors to the entropy, the combined effect without considering interaction would simply be the sum of the individual contributions. However, because N and C can interact (i.e., the presence of noise can affect the crosstalk and vice versa), this interaction can be accounted for through mutual information I(N;C). Thus, the total entropy H(S) considering the interaction can be expressed as:

$$H ( S ) = H ( N ) + H ( C ) - I ( N ; C )$$

This formula accounts for the unique information contributed by N and C minus the information that is redundant (shared between N and C).

To derive I(N;C), we can start from the definition of mutual information:

$$I ( N ; C ) = {\sum }_{n , c} p ( n , c ) log [ p ( n , c ) / p ( n ) p ( c ) ]$$

This requires knowing the joint probability distribution p(n,c), which describes how likely it will be to observe specific combinations of noise and crosstalk levels, and the marginal probability distributions p(n) and p(c), which describe the likelihood of observing specific levels of noise and crosstalk independently. By calculating these distributions, the mutual information I(N;C) can be evaluated to quantify the interaction between noise and crosstalk.

For a given distribution of N (e.g., Gaussian with mean un and variance σ²N) and C (potentially another Gaussian with mean μ_{C} and variance σ²_{C}), the entropies H(N) and H(C) can be calculated directly if the distributions are known. For Gaussian distributions, the entropy is given by:

$$H ( X ) = 1 / 2 log ( 2 π e {σ}_{X}^{2} )$$

Where X can be N or C, and e is the base of the natural algorithm.

To illustrate how mutual information might reduce the combined entropy, consider a simplified case where N and C are not independent but linearly related. The mutual information I(N;C) captures the extent to which knowing N reduces uncertainty about C. In cases of linear dependence, mutual information can be significant, indicating substantial overlap in the information N and C convey about the system's state.

A key takeaway from this is that mutual information allows us to account for the non0additive effects of noise and crosstalk on system entropy, refining our understanding of how these factors interact to influence the system's overall uncertainty. This conceptual framework can be extended or adapted based on specific system characteristics and the nature of the noise and crosstalk involved.

Some embodiments of this disclosure can include enhancement of DNN inference through random noise and inter-node interference using Compute Unified Device Architecture (CUDA) instructions. This can be applicable in the field of deep learning and graphics processing unit (GPU) programming, specifically to the optimization of neural network inference using the CUDA instruction set.

In one example, this can include loading neural network weights, biases, and associated data into GPU memory using CUDA memory management instructions; distributing the neural network's computational tasks across GPU threads, leveraging CUDA's parallelism capabilities; and, for each forward pass of an input through the network: calculating node outputs using CUDA kernels, wherein each kernel handles the computation for a single layer or a subset of nodes within a layer, injecting controlled random noise into node outputs using CUDA's built-in random number generation capabilities to modify the node's outputs, calculating inter-node interference by blending outputs of multiple nodes, wherein the interference function is executed as a separate CUDA kernel and involves operations like element-wise multiplication, convolution, or other operations that leverage the GPU's parallelism, adjusting the intensity of introduced random noise and interference based on feedback from the network's outputs, implemented through adaptive CUDA kernels that operate on feedback and adjust the noise and interference vectors accordingly, and aggregating final layer outputs to produce the network's prediction, with aggregation operations also executed using dedicated CUDA kernels.

Then, the processed outputs from the GPU memory can be returned to the primary memory or storage for further utilization or analysis.

This process also can include training the deep neural network using backpropagation or other optimization techniques, wherein gradient calculations, weight updates, and other training-specific operations are also carried out using CUDA kernels to leverage the GPU's computational capabilities. Additionally, the interference function, noise generation mechanism, and adaptive adjustment routines can be parameterized and configurable to cater to specific neural network architectures, datasets, or desired output characteristics. In some embodiments, the CUDA-based operations are optimized to handle varying sizes of input data, diverse neural network architectures, and different GPU architectures or configurations, ensuring scalable and efficient processing across multiple scenarios.

Some additional mathematical explanations will be provided here. For example, the forward pass calculation can be expounded on as follows.

For a given node:

$${y}_{n L} = f ( {w}_{nL} \cdot x + b )$$

where:
   y_{nL} is the output of node n in layer L.
   f is the activation function (e.g., ReLU, Sigmoid, etc.).
   w_{nL} is the weight vector of node n in layer L.
   x is the input vector.
   b is the bias.
The introduction of random noise ϵϵ modifies the equation as:

$${y}_{n L} = f ( {w}_{n L} \cdot x + b + ϵ )$$

Inter-node interference between nodes n1 and n2 might be represented as:

$${y}_{nintL} = {y}_{n 1 L} + {y}_{n 2 L} + I ( {y}_{n 1 L} , {y}_{n 2 L} )$$

with the interference function I as a specific mathematical operation (e.g., multiplication, convolution). The exact nature of I would be application-specific.

It may be useful to consider conceptual pseudocode for a GPU, though given the vastness of the task a high-level conceptual outline will be provided here:

```
Assembly
LOAD DATA input_data, GPU_MEMORY
LOAD DATA weights, GPU_MEMORY
LOAD DATA biases, GPU_MEMORY
FORWARD_PASS:
  LOAD input_data, REGISTER_A
  LOAD weights, REGISTER_B
  DOT_PRODUCT REGISTER_A, REGISTER_B, REGISTER_C ; Compute weighted sum
  ADD REGISTER_C, biases, REGISTER_C
  INJECT_NOISE REGISTER_C ; Pseudo-instruction to add noise
  ACTIVATE REGISTER_C ; Activation function
  STORE REGISTER_C, GPU_MEMORY
  ; Repeating above for subsequent layers ...
END FORWARD_PASS
```

As mentioned above, this is a very high-level representation. In reality, the assembly for GPU (like NVIDIA's PTX assembly language) will be much more complex, especially when considering parallelism, branching, etc., as will be appreciated by those of skill in the art.

It also can be helpful to consider memory optimization, according to one or more of the following techniques:
Memory Coalescing: Ensuring that consecutive threads access consecutive memory addresses, which reduces memory latency and increases bandwidth.
Shared Memory: Using the faster shared memory for frequent access data, but ensuring not to overflow as shared memory is limited.
Memory Pools: Pre-allocating chunks of memory for frequently-used data structures or arrays to prevent frequent memory allocations and deallocations.
Reduced Precision: By sticking to a single-precision floating point, or FP32, as indicated, memory usage is already optimized compared to higher precision formats. However, care should be taken that precision is adequate for the task.
Sparse Representations: If certain layers or nodes are inactive or have weights close to zero, using sparse matrix representations can reduce memory usage.
Batch Processing: Instead of processing one input at a time, batch multiple inputs together to leverage GPU parallelism and reduce per-input memory overhead.

In one embodiments, and given inputs x₁, x₂, . . . , x_{n×1}, x₂, . . . , xₙ, weights w₁, w₂, . . . , w_{nw1}, e₂, . . . , wₙ, and bias b, we want to compute:

$$Y = {\sum }_{i} = 1 {n}_{xi} {w}_{i} + b + ϵ$$

where ϵ is some random noise.
What is provided below is example PTX pseudocode:

assembly
; Assuming x values are in global memory at address x_addr
; Assuming w values are in global memory at address w_addr
; Assuming the result will be stored at address y_addr
; For simplicity, we are assuming n = 4 (four input neurons)
ld.global.f32 %r1, [x_addr]; ; Load x1 into register r1
ld.global.f32 %r2, [x_addr+4]; ; Load x2 into register r2
ld.global.f32 %r3, [x_addr+8]; ; Load x3 into register r3
ld.global.f32 %r4, [x_addr+12]; ; Load x4 into register r4
ld.global.f32 %w1, [w_addr]; ; Load w1 into register w1
ld.global.f32 %w2, [w_addr+4]; ; Load w2 into register w2
ld.global.f32 %w3, [w_addr+8]; ; Load w3 into register w3
ld.global.f32 %w4, [w_addr+12]; ; Load w4 into register w4
mul.f32 %p1, %r1, %w1; ; Multiply x1 with w1
mul.f32 %p2, %r2, %w2; ; Multiply x2 with w2
mul.f32 %p3, %r3, %w3; ; Multiply x3 with w3
mul.f32 %p4, %r4, %w4; ; Multiply x4 with w4
add.f32 %sum1, %p1, %p2; ; Add results of first two multiplications
add.f32 %sum2, %p3, %p4; ; Add results of next two multiplications
add.f32 %final, %sum1, %sum2; ; Add the two sums
; Adding bias (assuming bias is at address b_addr)
ld.global.f32 %bias, [b_addr];
add.f32 %y_without_noise, %final, %bias;
; Adding noise (for simplicity, we'll add a constant noise of 0.01)
add.f32 %y, %y_without_noise, 0.01;
; Store the result back to global memory
st.global.f32 [y_addr], %y;

What follows next is a basic feedforward neural network in Python, taking into account the weighted sum operation with bias and noise injection.

```
python
import numpy as np
class NeuralNetwork:
  def_init_(self, input_size, hidden_size, output_size):
    self.weights1 = np.random.randn(input_size, hidden_size)
    self.bias1 = np.random.randn(hidden_size)
    self.weights2 = np.random.randn(hidden_size, output_size)
    self.bias2 = np.random.randn(output_size)
  def activation(self, x):
    # Using sigmoid activation for simplicity
    return 1 / (1 + np.exp(−x))
  def forward(self, x):
    # First layer
    z1= np.dot(x, self.weights1) + self.bias1
    z1_with_noise = z1 + 0.01 * np.random.randn(*z1.shape) # Add random noise
    a1 = self.activation(z1_with_noise)
    # Second layer
    z2 = np.dot(a1, self.weights2) + self.bias2
    z2_with_noise = z2 + 0.01 * np.random.randn(*z2.shape) # Add random noise
    a2 = self.activation(z2_with_noise)
    return a2
# Example
nn = NeuralNetwork(input_size=3, hidden_size=4, output_size=2)
input_data = np.array([0.5, 0.2, 0.9])
output = nn.forward(input_data)
print(output)
```

This code initializes a simple 2-layer feedforward neural network. The NeuralNetwork class contains methods for initialization and forward propagation. During forward propagation, noise can be added to the output of each layer. The forward method computes the output for a given input, injecting random noise after the weighted sum at each layer. This is a rudimentary example for illustrative purposes.

Some embodiments of this disclosure relate to systems and methods of introducing noise into pretrained neural networks during inference to enhance performance, creativity, and generalization capabilities using specific techniques, alone or in combination. These techniques can be as follows.

### Dynamic Noise Injection:

Given a network output confidence C, and a noise function N(x) that produces noise based on input xx, we have:

$${N}_{n e w} = f ( C ) \times N ( x )$$

where f(C) can be a linear or nonlinear function determining noise amplitude.

### Structured Noise Patterns:

Instead of injecting purely random noise, use structured functions such as

$${N}_{s} = Asin ( kx )$$

where A is amplitude and k is the wave number.
Noise Masking with Attention:

Given attention weights A=[a₁, a₂, . . . , aₙ] for features [x₁,x₂, . . . , xₙ], noise N is injected in some embodiments as:

$${x}_{{i}^{′}} = {x}_{i} + ( 1 - {a}_{i} ) \times {N}_{( x i )}$$

### Feedback Loop Noise Injection:

Let y be the output, and N_{y} be the noise function dependent on y, the next input is perturbed as:

$${x}_{t} + 1 = {x}_{t} + {N}_{y} ( y )$$

### Layer-Specific Noise Regimes:

For a neural network with layers L₁, L₂, . . . . LₙL₁, L₂, . . . . Lₙ, noise functions N₁, N₂, . . . NₙN₁, N₂, . . . Nₙ can be defined with different characteristics for each layer.

### Noise as a Regularizer During Fine-Tuning:

The loss function LL during fine-tuning is modified as:

$${L}^{′} = L + λ \times ‖ N ( x ) ‖ 2$$

where λ is a regularization parameter.

### Noise Augmented Memory Networks:

Let RR and WW be read and write operations, respectively, on memory MM, such that noise can be introduced as:

$${R}^{′} = R + {N}_{r}$$

$${W}^{′} = W + {N}_{w}$$

### Conditional Noise Injection:

Given a condition CC and a base noise function NN, the noise is modified as:

$${N}^{′} = g ( C ) \times N$$

where g is a function determining the amplitude or pattern of noise based on C.

### Spatial and Temporal Noise for RNNs:

For a sequence x₁, x₂, . . . , xₜx₁, x₂, . . . , xₜ, spatial noise Ns and temporal noise Nt can be introduced as:

$${x}_{i}^{′} = {x}_{i} + {N}_{s ( i )} + {N}_{t ( t )}$$

### Meta-Learning for Noise Injection:

Train a meta-network M such that given an input sample x and a target network T it predicts the optimal noise N*:

$$N * = M ( x , T )$$

As will be appreciated by those of skill in the art, the various techniques and embodiments discussed herein can be applied singly or in various ways or combinations. Thus, what is presented herein is not a set of distinct ways of creating or injecting noise, or in training or applying neural networks or other AI systems. Rather, different types of networks or systems, or different situations or data sets, may cause selection of one or a set of techniques presented herein for review, analysis, or implementation in use.

Introducing noise into pretrained neural networks during the inference phase can provide many benefits and advantages. Firstly, introducing noise can combat the overfitting problem often associated with deep learning models, allowing them to generalize better on unseen data.

Next, the dynamic nature of some of the techniques discussed herein allows the network to adjust noise levels based on specific scenarios, thereby offering a balance between stability and creativity. The variability provided here can lead to enhanced creativity, especially in generative tasks, by pushing the network to explore novel solutions beyond its typical deterministic output.

Additionally, these methods could fortify neural networks against adversarial attacks. By training networks to operate in the presence of noise, they inherently learn to recognize and counteract malicious perturbations in the input.

Finally, these techniques also can pave the way for networks that can operate in unpredictable real-world scenarios in which clean and noise-free data is not always guaranteed.

To further illustrate features and advantages embodiments of this disclosure can provide, the following specific implementation examples are included.

Image Generation: In a Generative Adversarial Network (GAN) trained for art creation, dynamic noise injection can be used to produce a wider array of artistic styles, where the confidence measure determines the deviation from the network's “usual” style.

Text Generation: For a pretrained language model, structured noise patterns can be used to create texts with specific rhythmic or stylistic patterns, potentially producing poetry or prose with a distinctive “beat.”

Self-Driving Cars: In autonomous driving neural networks, noise masking with attention can be deployed. Crucial data, like the position of pedestrians, might be preserved with less noise, while less critical data, like the sky's appearance, can be subjected to higher noise levels, ensuring safety while allowing for adaptive reactions to new environments or conditions.

Recommendation Systems: Feedback loop noise injection can be applied in recommendation algorithms. Depending on the user's interaction with a recommended item, the system adapts the noise level for the next recommendation, ensuring diversity in suggestions.

Finance: In time-series prediction models for stock prices, spatial and temporal noise for recurrent neural networks (RNNs) can be utilized. This allows the model to be more resilient to sudden market changes and provides a range of possible predictions instead of a fixed deterministic output.

An additional consideration is analysis of emergent error correction observed in test systems of embodiments of this disclosure. The experimental analysis of emergent error correction in DNNs, induced by the injection of random noise during training or inference, offers a fascinating insight into the resilience and adaptability of these systems. This last section will discuss the methodology, observations, and implications of such experimental endeavors, shedding light on how deliberate perturbations can paradoxically enhance a neural network's performance or robustness.

In one experimental setup, random noise was systematically introduced to the inputs, weights, or layers of a DNN at various stages of its operation-either during the training phase, the inference phase, or both. The noise took several forms, including Gaussian noise, uniform noise, or dropout (a form of noise in which certain units are randomly omitted during training). The primary goal of these experiments was to observe how the neural network adapts to these perturbations and whether this adaptation leads to a form of emergent error correction.

Key metrics for evaluation included the network's accuracy on a held-out validation set, its robustness to further noise or adversarial attacks, and any changes in the internal representation of data as observed through techniques like feature visualization and activation analysis. The following observations were made.

Robustness to Adversarial Attacks: Networks trained with noise injection tend to exhibit increased resilience against adversarial attacks, suggesting that the noise helps the network learn more generalizable features rather than overfitting to the training data.

Improved Generalization: In some cases, networks exposed to noise during training achieve higher accuracy on validation datasets, indicating that noise can act as a regularizer, preventing overfitting and encouraging the learning of more robust features. By introducing noise, the network is compelled to focus on essential patterns rather than memorizing the training data, thus enhancing its ability to generalize to unseen data.

Emergent Error Correction Mechanisms: Interestingly, networks trained with noise sometimes develop internal mechanisms for error correction. These mechanisms enable the network to recognize and rectify errors during both training and inference phases, leading to improved performance and resilience. This self-correcting behavior arises because the network learns to differentiate between signal and noise, effectively filtering out irrelevant variations and maintaining focus on the core data structure. As a result, the network becomes more adept at handling real-world scenarios where data can be noisy or incomplete, further boosting its accuracy and reliability in practical applications.

It can also be of interest to consider whether there are physical analogs to any of the techniques discussed here, including with respect to whether any would allow for natural error prone operations. As a beginning query, it could be asked whether embodiments could be run on an analog adder to gain speed versus simulating one.

Translating the concepts of noise injection and crosstalk from digital deep neural networks (DNNs) to analog systems, including analog computing devices like adders, opens fascinating avenues for exploring natural error correction and resilience mechanisms. Analog computing, inherently more susceptible to noise and interference than its digital counterpart, can leverage these phenomena to enhance computation in certain contexts, potentially offering speed and efficiency advantages over digital simulations.

Analog computing processes information in a continuous form, often employing physical quantities such as electrical voltages or currents to represent information. This contrasts with digital computing, which uses discrete states (e.g., 0s and 1s) to represent information. The continuous nature of analog signals makes them naturally prone to noise and variations, which can be considered analogous to the random noise injection in DNNs.

Incorporating deliberate noise or exploiting crosstalk in analog computing could enhance its computational capabilities or efficiency, mirroring the emergent error correction observed in DNNs. Here are examples of how these concepts could potentially apply:
Noise Injection for Robustness: In analog circuits, injecting noise into the system during operation or calibration phases could help in identifying and reinforcing robust pathways for signal processing. This is akin to training a neural network with noise to improve its generalization. For analog circuits, such as adders, this could mean developing designs that are inherently more tolerant to variations and interference, potentially leading to faster and more resilient operations.
   Crosstalk as a Feature: Crosstalk, typically seen as a deleterious effect in both digital and analog circuits, could be harnessed to perform certain computational tasks more efficiently. In an analog adder, for instance, controlled crosstalk between circuit elements could be used to perform parallel operations more effectively. By intentionally designing circuits to take advantage of crosstalk, it is possible to facilitate simultaneous signal processing, thereby increasing computational throughput and reducing latency. This approach leverages the inherent properties of crosstalk to enhance performance, turning a traditionally negative phenomenon into a beneficial feature. Additionally, such methods could lead to innovations in circuit design, where crosstalk is used to optimize power consumption and spatial efficiency, ultimately contributing to the development of more compact and powerful computational devices. In an embodiment, a method of making an artificial intelligence (AI) system more creative can comprise intentionally injecting noise into the AI system. The noise can be random. The noise can be controlled random noise. The controlled random noise can be adjusted to control at least one of a magnitude or a behavior of the controlled random noise. The random noise can be derived from a Gaussian distribution.

The AI system can be a neural network. Intentionally or deliberately injecting noise into the AI system can enhance creativity of the AI system via controlled interference patterns between adjacent layers of the neural network.

Input data can be provided to the AI system, and output data can be received from the AI system, with the output data based on the input data and the noise. The output data can be varied as a result of intentionally injecting noise into the AI system. The input data can be transformed with the noise using a Fast Fourier Transform (FFT).

The AI system can comprise an AI inference algorithm, and intentionally injecting noise into the AI system can comprise providing the noise to the AI inference algorithm.

The AI system can be a quantum neural network, and intentionally injecting noise into the quantum neural network can enhance creativity of the quantum neural network by introducing controlled interference patterns between adjacent layers of the quantum neural network. The quantum neural network can be a deep quantum neural network. The deep quantum neural network can be trained using qubits on a quantum computer. Intentionally injecting noise into the deep quantum neural network can comprise injecting random noise and instigating inter-node interference during inference, wherein patterns of the random noise and the inter-node interference can be controlled to enhance output data of the deep quantum neural network.

The AI system can be trained using at least one of a polynomial regression model, random noise integration, dropout, or an FFT transformation.

A system can comprise at least one processor and memory storing instructions to intentionally inject noise into an artificial intelligence (AI) system. The system can comprise a quantum computer system. Output data of the system can be varied as a result of intentionally injecting the noise. The noise can be random.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

It should be understood that the individual operations used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112 (f) are not to be invoked unless the specific terms “means for” or “step for” are recited in a claim.

What is claimed is:

1. A method of making an artificial intelligence (AI) system more creative, the method comprising:
intentionally injecting noise into the AI system.

2. The method of claim 1, wherein the noise is random.

3. The method of claim 2, wherein the noise is controlled random noise.

4. The method of claim 3, further comprising adjusting the controlled random noise to control at least one of a magnitude or a behavior of the controlled random noise.

5. The method of claim 2, wherein the random noise is derived from a Gaussian distribution.

6. The method of claim 1, wherein the AI system is a neural network.

7. The method of claim 6, wherein intentionally injecting noise into the AI system enhances creativity of the AI system via controlled interference patterns between adjacent layers of the neural network.

8. The method of claim 1, further comprising:
providing input data to the AI system; and
receiving output data from the AI system based on the input data and the noise.

9. The method of claim 8, wherein the output data is varied as a result of intentionally injecting noise into the AI system.

10. The method of claim 8, further comprising transforming the input data with the noise using a Fast Fourier Transform (FFT).

11. The method of claim 1, wherein the AI system comprises an AI inference algorithm, and intentionally injecting noise into the AI system comprises providing the noise to the AI inference algorithm.

12. The method of claim 1, wherein the AI system is a quantum neural network, and intentionally injecting noise into the quantum neural network enhances creativity of the quantum neural network by introducing controlled interference patterns between adjacent layers of the quantum neural network.

13. The method of claim 12, wherein the quantum neural network is a deep quantum neural network.

14. The method of claim 13, further comprising training the deep quantum neural network using qubits on a quantum computer.

15. The method of claim 13, wherein intentionally injecting noise into the deep quantum neural network further comprises injecting random noise and instigating inter-node interference during inference, wherein patterns of the random noise and the inter-node interference are controlled to enhance output data of the deep quantum neural network.

16. The method of claim 1, further comprising training the AI system using at least one of a polynomial regression model, random noise integration, dropout, or an FFT transformation.

17. A system comprising:
at least one processor and memory storing instructions to intentionally inject noise into an artificial intelligence (AI) system.

18. The system of claim 17, wherein the system comprises a quantum computer system.

19. The system of claim 17, wherein output data of the system is varied as a result of intentionally injecting the noise.

20. The system of claim 17, wherein the noise is random.
